(19) United States
(12) Patent Application Publication
(10) Pub. No.: US 2025/0003757 A1
(43) Pub. Date: Jan. 2, 2025

(54) SELECTIVE GLOBAL POSITIONING SYSTEM NAVIGATION

(71) Applicant: International Business Machines Corporation, Armonk, NY (US)

(72) Inventors: Michael S. Gordon, Croton on Hudson, NY (US); Mattias Fitzpatrick, Mount Kisco, NY (US); Brian Paul Gaucher, Brookfield, CT (US); Kevin W. Brew, Niskayuna, NY (US)

(21) Appl. No.: 18/342,879

(22) Filed: Jun. 28, 2023

(51) Int. Cl. G01C 21/34

(52) U.S. Cl. CPC G01C 21/3461; G01C 21/3415

(57) ABSTRACT

According to one embodiment, a method, computer system, and computer program product for selective GPS navigation is provided. The embodiment may include determining a type of a vehicle operated by a user. The embodiment may also include, in response to determining a segment of a navigational route being traversed by the vehicle prohibits the type or is obstructed, presenting a notification to the user of the prohibition or the obstruction through a graphical user interface associated with a device dictating the navigational route. The embodiment may further include calculating a reroute that avoids the prohibition and/or the obstruction. The embodiment may also include presenting the reroute to the user.

### BACKGROUND

The present invention relates generally to the field of computing, and more particularly to navigation systems.

A traffic control system relates to technology that aims to ensure the safe and efficient traversal of a transportation system. Typically, traffic control systems include traffic laws and procedures, physical objects (e.g., roadway signage, markings, and lights), and distributed technologies (e.g., computer navigation systems). Many jurisdictions provide standards and procedures of accepted traffic control devices to ensure uniform adoption of devices ensuring individuals will encounter the same devices throughout the jurisdiction.

Traffic control systems, like many aspects of everyday life, are becoming increasingly advanced through the integration of computing technology. A modern example of a traffic control system is the deployment of global positioning system (GPS) technology for roadway navigation by both commercial and passenger vehicles. Roadway navigation may be used to calculate a navigation route from a source location to a destination location using a GPS satellite network and is used by many individuals and organizations daily worldwide. The ability to utilize roadway navigation applications on a variety of devices has enabled its mass adoption. For example, users may utilize a vehicle's onboard navigation system or one of a variety of third-party applications installed on a user device, such as a smartphone.

### SUMMARY

According to one embodiment, a method, computer system, and computer program product for selective GPS navigation is provided. The embodiment may include determining a type of a vehicle operated by a user. The embodiment may also include, in response to determining a segment of a navigational route being traversed by the vehicle prohibits the type or is obstructed, presenting a notification to the user of the prohibition or the obstruction through a graphical user interface associated with a device dictating the navigational route. The embodiment may further include calculating a reroute that avoids the prohibition and/or the obstruction. The embodiment may also include presenting the reroute to the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a selective GPS navigation process according to at least one embodiment.

FIG. 3 illustrates an operational flowchart for an exemplary decision process through selective GPS navigation according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to navigation systems. The following described exemplary embodiments provide a system, method, and program product to, among other things, determine when a user is traversing a route in a vehicle inappropriate for or prohibited for the route and generating a corrected route that traverses roadways appropriate for the user vehicle. Therefore, the present embodiment has the capacity to improve the technical field navigation system by predicting roadway prohibitions and/or obstructions making traversal of the roadways prohibitive or inappropriate before a user may become aware of such conditions and modify the traversal route to avoid such prohibitions and obstructions.

As previously described, a traffic control system relates to technology that aims to ensure the safe and efficient traversal of a transportation system. Typically, traffic control systems include traffic laws and procedures, physical objects (e.g., roadway signage, markings, and lights), and distributed technologies (e.g., computer navigation systems). Many jurisdictions provide standards and procedures of accepted traffic control devices to ensure uniform adoption of devices ensuring individuals will encounter the same devices throughout the jurisdiction.

Traffic control systems, like many aspects of everyday life, are becoming increasingly advanced through the integration of computing technology. A modern example of a traffic control system is the deployment of global positioning system (GPS) technology for roadway navigation by both commercial and passenger vehicles. Roadway navigation may be used to calculate a navigation route from a source location to a destination location using a GPS satellite network and is used by many individuals and organizations daily worldwide. The ability to utilize roadway navigation applications on a variety of devices has enabled its mass adoption. For example, users may utilize a vehicle's onboard navigation system or one of a variety of third-party applications installed on a user device, such as a smartphone.

Roadway design is extremely technical due to various factors during the design process that require certain restrictions be placed on specific roadways. For example, limitations caused by overhead obstructions or a steep grade may require certain roadways to prohibit trucks, buses, and commercial vehicles. However, some drivers may be unaware of these restrictions due to their unfamiliarity with driving certain vehicle types or configurations, such as an individual that rents a box truck for a residential move or a person that only occasionally utilizes the towing capabilities of their personal vehicle. Exacerbating this situation are laws that allow individuals to rent and operate certain vehicles, such as box trucks and trailers, with a standard issued license while also prohibiting those same vehicles from being operated on certain roadways, such as parkways in New York State. Being unfamiliar with or forgetful of roadway restrictions may result in a catastrophic event, such as impacting an overhead bridge.

Typical GPS navigational systems aim to aid users in traversing roadways and the restrictions placed on such roadways. For example, some GPS navigation devices are designed for use by drivers of commercially driven vehicles which require a commercial driver's license (CDL) to operate and avoid roadways on which such vehicles are prohibited from driving. However, most passenger vehicle-oriented GPS navigation systems only include conventional navigation features that allow users to choose between standard options when selecting a traversal route to a destination, such as shortest distance, shortest time duration, and/or avoiding highways or toll roads. As such, it may be advantageous to, among other things, provide a navigational system that considers a vehicle type and other characteristics when choosing an initial traversal route and provides real-time updates due to roadways obstructions that prohibit safe traversal of a navigational route.

According to at least one embodiment, a selective GPS program may determine a type of vehicle driven by a user so that GPS navigation is capable of determining a route that suit the constraints imposed by the vehicle. The selective GPS program may utilize any number of available ways for determining what vehicle a user is operating which may be used in isolation or in combination to provide a robust, and more accurate, determination of the vehicle type. Once the selective GPS program determines a vehicle type, the selective GPS program may ingest the information into a GPS navigation system as additional metadata to take into consideration when generating a route. The selective GPS program may also provide alerts to the user if an incorrect route is taken while in a specific vehicle type, such as a commercial vehicle or a vehicle towing a trailer being prohibited on certain roadways. Furthermore, the selective GPS program may communicate a distance measurement from and a time duration, based on a current vehicle speed, until a possible impedance obstacle on a roadway preventing traversal by a vehicle, such as low bridges, to ensure the user corrects their course by exiting the parkway before a disaster occurs. In such a situation, the selective GPS program may present a suggested exit from the roadway on a navigation system graphical user interface.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

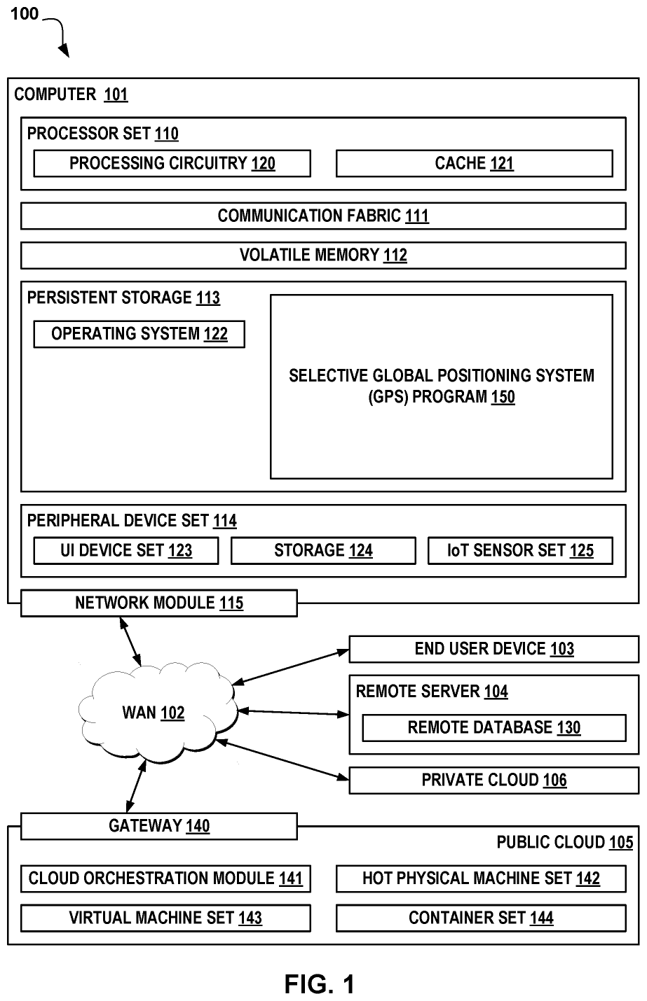

Referring now to FIG. 1, computing environment 100 contains an example of an environment for the execution of at least some of the computer code involved in performing the inventive methods, such as selective GPS program 150. In addition to selective GPS program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and selective GPS program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in selective GPS program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in selective GPS program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the selective GPS program 150 may capture various characteristic information about a vehicle in which a user is traveling including, but not limited to, a vehicle type. The selective GPS program 150 may utilize the characteristic information and a current location of the vehicle on a roadway or a projected route calculated by a navigation system to determine whether the vehicle is prohibited on a certain roadway or if a current obstruction is present preventing traversal of the roadway by the vehicle. If the selective GPS program 150 determines the vehicle is prohibited on the current roadway, on a future roadway along a projected route, or is obstructed preventing traversal by the vehicle, the selective GPS program 150 may notify the user and calculate a reroute.

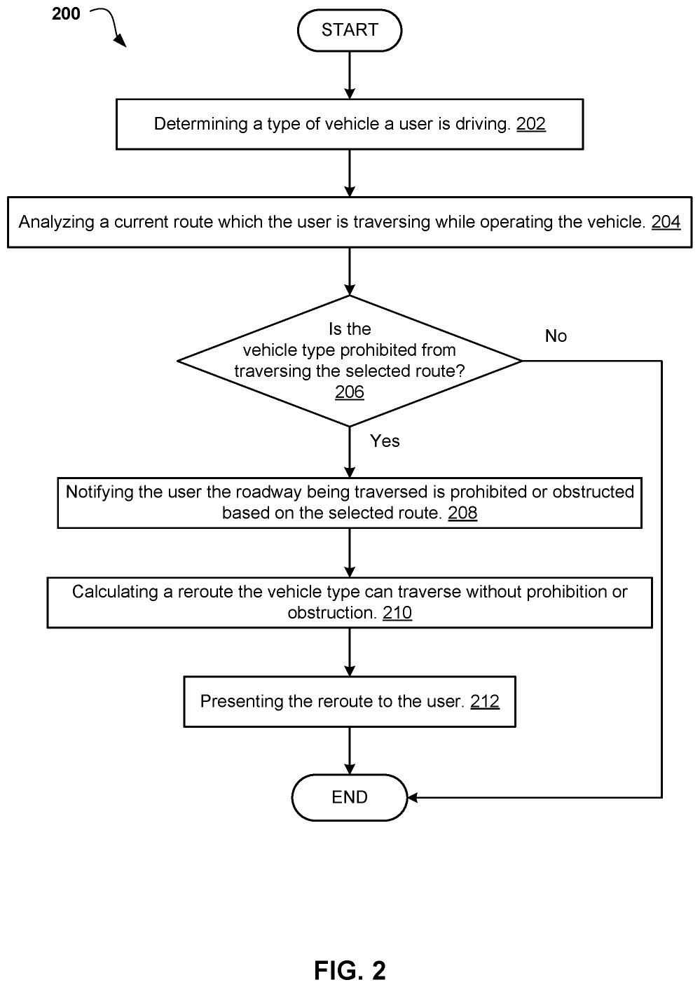

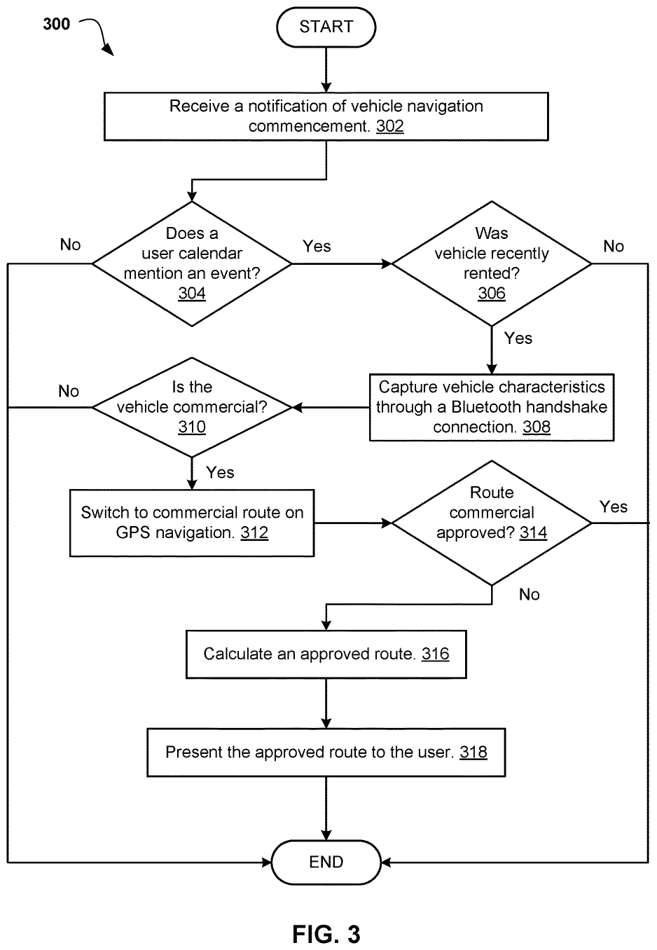

Additionally, prior to initially performing any actions, the selective GPS program 150 may perform an opt-in procedure. The opt-in procedure may include a notification of the data the selective GPS program 150 may capture and the purpose for which that data may be utilized by the selective GPS program 150 during data gathering and operation. Furthermore, notwithstanding depiction in computer 101, the selective GPS program 150 may be stored in and/or executed by, individually or in any combination, end user device 103, remote server 104, public cloud 105, and private cloud 106. The selective GPS method is explained in more detail below with respect to FIGS. 2 and 3.

Referring now to FIG. 2, an operational flowchart illustrating a selective GPS process 200 is depicted according to at least one embodiment. At 202, the selective GPS program 150 determines a type of vehicle a user is driving. The selective GPS program 150 may determine a type of vehicle the user is driving through a variety of data collection and/or identification methods including, but not limited to, a calendar entry showing a vehicle being rented, credit card transaction information, a change in vehicle tongue weight to a positive value when a trailer is on a hitch, level of the vehicle (e.g., vehicle sits lower in the rear when towing a trailer), view from a side view or rear-view window, view from a back-up camera, view from a cellphone camera, tolling authority database information, GPS data indicating usage of a weigh station, information captured from an on-board diagnostic indicator (OBDI) connector, a vehicle identification number (VIN), tire inflation sensor information, sound/vibration emitted from the vehicle and captured by a user device, and accelerometer information captured by the vehicle itself or a user device.

In one or more embodiments, based on the type of information gathered to identify the type of the vehicle, the selective GPS program 150 may require further information, perhaps from one or more third party databases (e.g., remote database 130) to fully identify the class of the vehicle. For example, if the selective GPS program 150 determines the vehicle emits sound as a specific amplitude, the selective GPS program 150 may require a search of a third-party data base to identify what type of vehicles are capable of emitting sounds at that specific amplitude. Conversely, if the selective GPS program 150 captures images from a user device cellphone camera, the selective GPS program 150 may utilize image recognition technology to identify the vehicle type or class rather than requiring a search of a third-party database.

In one or more other embodiments, the selective GPS program 150, despite not requiring a search to determine the type of the vehicle, may execute a search of a third-party database to verify its prediction. For example, the selective GPS program 150 may perform an image search of a third-party database to verify that a vehicle type or class identified through image recognition does indeed match the identified vehicle type.

Then, at 204, the selective GPS program 150 analyzes a current route which the user is traversing while operating the vehicle. Through a communicative connection with a GPS navigation program, the selective GPS program 150 may analyze the user's current route while operating the vehicle to determine roadways along which the vehicle is predicted to traverse. The selective GPS program 150 may determine various characteristics and/or statistics related to each roadway along which the vehicle is expected to traverse based on the current route. For example, the selective GPS program 150 may determine the type of each roadway along the traversal path (e.g., highway, parkway, etc.), dimensions of each roadway, a surface of each roadway (e.g., paved, gravel, dirt, etc.), and whether certain types of vehicles are prohibited from traversing the roadway.

Next, at 206, the selective GPS program 150 determines whether the vehicle type or class is prohibited from traversing the selected route. Using the vehicle type determined in step 202 and the various characteristics and/or statistics related to each roadway along the current route being traversed by the user in the vehicle determined in step 204, the selective GPS program 150 may determine whether the vehicle type or class is prohibited on one or more roadways either currently being traversed or that will be traversed during a segment of the current route provided by the GPS navigation system. If the selective GPS program 150 determines the vehicle type is prohibited on the current route (step 206, “Yes” branch), then the selective GPS process 200 may proceed to step 208 to notify the user the vehicle is prohibited on a roadway being traversed or will be traversed along the current route. If the selective GPS program 150 determines the vehicle type or class is allowed on the current route (step 206, “No” branch), then the selective GPS process 200 may terminate.

In one or more embodiments, the selective GPS program 150 may further determine whether the roadway is obstructed in a manner that prevents traversal by the vehicle or the vehicle type. The obstruction may be an entity that either fully blocks a roadway from all traffic (e.g., a tree fallen completely across a roadway) or partially blocking a roadway so as to prevent passage by the vehicle or vehicles within the vehicle class (e.g., low hanging wires or bridges that prevent vehicles of a certain height from passing underneath). The selective GPS program 150 may determine a roadway is obstructed through one or more various identification techniques including, but not limited to, image recognition or analysis, speech-to-text, audio recognition, manual user interaction with a digital map, and/or capturing information from a third-party database. For example, the selective GPS program 150 may identify an obstruction in a roadway ahead of the vehicle through image analysis of a video feed from a dashboard camera either on the vehicle or another vehicle ahead of the vehicle that shares images to a cloud-based server for analysis. Similarly, the selective GPS program 150 may retrieve information from a third-party public database, such as a highway information database, that provides current roadway hazards and characteristics.

Then, at 208, the selective GPS program 150 notifies the user a roadway on the route being traversed is prohibited or obstructed. If the selective GPS program 150 determines a roadway on the route being traversed by the user operating the vehicle is prohibited for the type of vehicle or obstructed in manner preventing safe traversal, the selective GPS program 150 may notify the user of the prohibition or obstruction. The selective GPS program 150 may present the notification to the user on a graphical user interface of a device display screen. For example, the selective GPS program 150 may display an alert on a navigational system display screen (e.g., vehicle equipped system or a third-party navigational application operating on a smart device) or a vehicle heads up display (HUD). In the notification, the selective GPS program 150 may provide detailed information as to the prohibition or instruction. For example, the selective GPS program 150 may indicate the type or class of vehicle the user is operating is prohibited on a specific roadway so a reroute is necessary or that a low overpass is located along the roadway that the height specifications for the vehicle type or cargo the vehicle is towing exceed a threshold for the overpass. In one or more embodiments, the selective GPS program 150 may further include in the notification one or more alternate routes the user may take to avoid the prohibition or obstruction preventing the user from traversing the current route in the vehicle because of the vehicle type.

Next, at 210, the selective GPS program 150 calculates a reroute the vehicle type or class can traverse without prohibition or obstruction. Upon transmitting and presenting the notification to the user, the selective GPS program 150 may calculate a reroute for the vehicle that allows for the next best route for the vehicle to travel to the destination. The reroute may be based on user configuration as either the next best route based on time, distance, fewest lights, most highways traveled, least traffic based on vehicles per mile of roadway, or any other configurable setting. In one or more embodiments, the selective GPS program 150 may instruct the navigational system to calculate the reroute with an additional qualifier that the specific prohibited roadway or segment of roadway that is obstructed be avoided in the reroute.

Then, at 212, the selective GPS program 150 presents the reroute to the user. Similar to the notification provided in step 208, the selective GPS program 150 may present, or instruct the navigational system to present, the reroute to the user via a device display screen associated with the navigational system providing route guidance to the user while the user is operating the vehicle.

In one or more embodiments, the selective GPS program 150 may require confirmation from the user before enacting the reroute and canceling the original route containing traversal over the prohibited roadway or obstructed roadway segment. Such confirmation may be preferable in situations where the user, despite operating a prohibited vehicle or a vehicle that may interact with the obstacle, is necessary in the prohibited or obstructed segments of the roadway. For example, if an emergency services vehicle, such as a fire truck, is required on a passenger vehicle only parkway or when a tractor trailer carrying a bridge support beam for delivery to a construction site repairing a low overpass bridge.

Referring now to FIG. 3, an operational flowchart for an exemplary decision process 300 through selective GPS navigation, according to at least one embodiment. The exemplary decision process 300 illustrates a use case embodiment and decision process followed by the selective GPS program 150 during operation. Certain aspects, discussed more broadly in FIG. 2, may be narrowly discussed during the exemplary decision process 300 but are not intended to be limiting on the capabilities of the selective GPS program 150. At 302, the selective GPS program 150 receives an indication that the vehicle navigation has commenced. The selective GPS program 150 may determine that the vehicle navigation has commenced through a communication transmission between the selective GPS program 150 and a navigation system, an audio cue emitted by the navigation system, or a user interaction with a graphical user interface of a user device. For example, the selective GPS program 150 and the navigation system may be configured to exchange a notification when the user has entered a destination and the navigation system has begun directing the user to the destination. Similarly, the selective GPS program 150 may utilize audio recognition technology or speech-to-text technology to determine that an audio cue (e.g., “Please proceed to . . . ”) has been emitted from a speaker associated with the navigational system thus indicating the commencement of navigation. Furthermore, the selective GPS program 150 may be capable of determining that a user is interacting with a graphical user interface associated with the navigational system, through communicative coupling with the navigational system or image recognition of the device display screen, and determine navigation to a destination has commenced when the user confirms a proposed route presented by the navigation system.

Then, at 304, the selective GPS program 150 determines whether a user calendar mentions an event. In order to understand more details surrounding the vehicle used to traverse the route, the selective GPS program 150 may capture information about an event on a user calendar. The selective GPS program 150 may analyze information indicative that the user may be traversing roadways and/or utilizing a specific vehicle type or class. For example, the selective GPS program 150 may identify a calendar entry indicating that the user plans to move across town from one apartment to another. As an additional example, the selective GPS program 150 may identify that the user is scheduled to pick up a rental box truck at a specific time on a specific date. In one or more embodiments, the user calendar may be a personal calendar or a work calendar. The selective GPS program 150 may obtain access to the user calendar information through the previously described opt-in procedure and may utilize optical character recognition and image recognition to determine the contents of specific calendar entries. Furthermore, the selective GPS program 150 may analyze calendar entries within a preconfigured window before and after the current date and time due to those dates and times being of increased relevancy to the user's current actions. If the selective GPS program 150 determines that the user calendar does not mention an event (step 304, “No” branch), then the exemplary decision process 300 may terminate. If the selective GPS program 150 determines a user calendar mentions an event (step 304, “Yes” branch), then the selective exemplary decision process 300 may continue to step 306 to determine whether a vehicle was recently rented.

Next, at 306, the selective GPS program 150 determines whether a vehicle was recently rented. If the selective GPS program 150 determines an event is present on the user calendar, the selective GPS program 150 may further analyze the event to determine whether the user may have rented a vehicle recently based on the content of the calendar entry. In one embodiment, the selective GPS program 150 may determine whether a vehicle was rented by the user through analysis of credit card information, access to a third-party repository, or through location data. The selective GPS program 150 may receive information regarding credit card purchases showing the user paid for a rental vehicle at a specific price, which itself may infer the type or class of vehicle rented due to the price paid for the rental compared to a local, regional, or national price paid for such rentals. Additionally, the selective GPS program 150 may be communicatively coupled with a third-party repository, such as remote database 130, associated with a vehicle rental company through an application programming interface. The selective GPS program 150 may receive various data items related to vehicle rental information for the user such as, but not limited to, rental date, rental time, vehicle type, vehicle make, vehicle model, vehicle engine type, vehicle fuel grade, etc. Furthermore, the selective GPS program 150 may receive user location data through a user device that may be correlated with third-party mapping applications to show the user was physically present at a vehicle rental facility at a specific date and time.

Additionally, as previously described, the selective GPS program 150 may utilize optical character recognition and/or image recognition to analyze the presence of each calendar entry on the user calendar. Additionally, through optical character recognition and image recognition technology, the selective GPS program 150 may determine the content of each calendar entry to identify an event for which the entry relates or is tangential to the entry. Upon determining the content of the entry, the selective GPS program 150 may utilize artificial intelligence and/or machine learning technologies to predict whether a user is likely to rent a vehicle to perform acts related to the calendar entry. For example, continuing the previous scenario when the calendar entry relates to a crosstown move, the selective GPS program 150 determines that such events typically relate to users renting moving vehicles. In one or more embodiments, the selective GPS program 150 may require manual preconfiguration or may make one or more assumptions as to vehicles the user owns or has access to when determining whether the user may rent a vehicle. For example, if the selective GPS program 150 determines a user purchases 10 gallons of gasoline regularly when filling up their vehicle with gasoline, the selective GPS program 150 may determine the user has a small vehicle due to the gas tank size and that vehicle does not have a large storage capacity thereby requiring the user to rent a vehicle when performing the previously described moving event.

If the selective GPS program 150 determines that a vehicle was recently rented (step 306, “Yes” branch), then the exemplary decision process 300 may proceed to step 308 to capture the vehicle characteristics through a Bluetooth handshake connection. If the selective GPS program 150 determines the vehicle was not recently rented (step 306, “No” branch), then the selective exemplary decision process 300 may terminate.

Then, at 308, the selective GPS program 150 captures vehicle characteristics through a Bluetooth handshake connection. Once the selective GPS program 150 determines the vehicle is a rented vehicle, the selective GPS program 150 may establish a Bluetooth connection between a user device, such as EUD 103 or computer 101, to capture vehicle characteristic information through a handshake connection. The vehicle characteristic information may include, but is not limited to, a VIN number that the selective GPS program 150 may further utilize to establish a vehicle type or class. Although this exemplary step is discussed with respect to identifying vehicle characteristic information through a Bluetooth handshake connection, the selective GPS program 150 may capture the vehicle characteristic information in a number of various ways that do not involve a Bluetooth handshake connection as described further in step 202.

Next, at 310, the selective GPS program 150 determines whether the vehicle is a commercial vehicle. Based on a comparison of the captured vehicle characteristics from step 308 against standard dimensions for various commercial vehicles and vehicle types, the selective GPS program 150 may determine whether the vehicle operated by the user is a commercial vehicle. The selective GPS program 150 may obtain the standard dimensions for various commercial vehicles and vehicle types through a search of a third-party repository, such as remote database 130, or through a local database, such as storage 124, of commercial vehicle dimensions.

If the selective GPS program 150 determines the vehicle is a commercial vehicle (step 310, “Yes” branch), then the exemplary decision process 300 may proceed to step 312 to switch to a commercial route on GPS navigation. If the selective GPS program 150 determines the vehicle is not a commercial vehicle (step 310, “No” branch), then the selective exemplary decision process 300 may terminate.

Then, at 312, the selective GPS program 150 switches to a commercial navigation mode through GPS navigation. Once the selective GPS program 150 determines the user is operating a commercial vehicle, the selective GPS program 150 may switch navigation to a setting appropriate for calculating routes for commercial vehicles. The commercial vehicle navigation mode may be native to the selective GPS program 150 or to the navigation system to which the selective GPS program 150 is communicatively coupled. If the commercial vehicle mode is native to the navigation system, the selective GPS program 150 may instruct the navigation system to switch to a commercial vehicle mode and further instruct the navigation system to perform each of the remaining steps of the selective exemplary decision process 300.

Next, at 314, the selective GPS program 150 determines whether the route is approved for commercial vehicles. While in the commercial vehicle mode, the selective GPS program 150 may analyze the current route calculated by the navigation system to determine whether a commercial vehicle is permitted on each roadway segment of the route. This analysis may require the selective GPS program 150 to fetch further information related to roadway characteristics from one or more third-party databases, such as remote database 130, as is described in step 204. If the selective GPS program 150 determines the current route is approved for traversal by commercial vehicles (step 314, “Yes” branch), then the exemplary decision process 300 may terminate. If the selective GPS program 150 determines the current route is not approved for traversal by commercial vehicles (step 314, “No” branch), then the selective exemplary decision process 300 may continue to step 316 to calculate an approved route.

Then, at 316, the selective GPS program 150 calculates an approved route. When the selective GPS program 150 determines a current route of traversal to a destination by a user operating a commercial vehicle is not approved (i.e., prohibited or obstructed), the selective GPS program 150 may recalculate the route, or calculate a reroute, to only include roadways permissive of commercial traffic. The selective GPS program 150 may calculate the reroute independently through standard route calculation technology or, in one or more embodiments, instruct a navigation system to calculate the reroute with the parameter that the roadways prohibiting commercial vehicles or an identified obstacle for the user's vehicle be avoided in the reroute.

In one or more embodiments, the selective GPS program 150 may add additional parameters based on one or more user configurations. For example, the selective GPS program 150 may be configured to calculate the reroute based on a closest time of traversal to the original route or a closest total travel distance to the original route.

Next, at 318, the selective GPS program 150 presents the approved route to the user. Once the reroute has been calculated, the selective GPS program 150 may present the route to the user through a graphical user interface of the navigation system. The presentation of the reroute to the user may be performed substantially similar to the presentation described in step 212.

It may be appreciated that FIGS. 2 and 3 provide only an illustration of one implementation and do not imply any limitations with regard to how different embodiments may be implemented. Many modifications to the depicted environments may be made based on design and implementation requirements. For example, in one or more embodiments, if the selective GPS program 150 determines a user is traversing a roadway on which the type or class of vehicle driven by the user is prohibited, the selective GPS program 150 may transmit a notification to emergency services personnel based on administrator or developer configurations. This notification may be configured as an alert to warn of a potential catastrophic incident rather than a notification and proof of a traffic violation by the user as well as include an indication of the type of emergency services that may be required based on the characteristics of the user vehicle. For example, if the roadway includes a low level bridge and the user vehicle is a tanker truck carrying volatile compounds, the selective GPS program 150 may instruct emergency services that a fire suppression team, medical personnel, and a hazardous materials crew may be required in the event of a collision between the user vehicle and the low level bridge.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
determining a type of a vehicle operated by a user;
in response to determining a segment of a navigational route being traversed by the vehicle prohibits the type or is obstructed, presenting a notification to the user of the prohibition or the obstruction through a graphical user interface associated with a device dictating the navigational route;
calculating a reroute that avoids the prohibition and/or the obstruction; and
presenting the reroute to the user.

2. The method of claim 1, wherein the calculating comprises calculating a reroute that has a shortest time duration to a destination of two or more possible routes to the destination.

3. The method of claim 1, wherein the calculating comprises calculating a reroute that has a shortest distance to a destination of two or more possible routes to the destination.

4. The method of claim 1, wherein presenting the notification further comprises:
transmitting a warning notification to one or more emergency service personnel of a possible catastrophic event due to the vehicle traversing the navigational route.

5. The method of claim 4, wherein the warning notification comprises characteristic information of the vehicle and a type of emergency services required for the possible catastrophic event.

6. The method of claim 1, wherein the notification to the user is presented on a device display screen with information relating to a type of, a distance to, a time duration until the vehicle reaches the prohibition or the obstruction, and one or more alternate routes that avoid the prohibition or the obstruction.

7. The method of claim 1, wherein the type is determined through a data selected from a group consisting of a calendar entry showing the vehicle being rented, credit card transaction information, a change in vehicle tongue weight to a positive value when a trailer is on a hitch, a level of the vehicle, a view from a side view or a rear-view window, a view from a back-up camera, a view from a cellphone camera, tolling authority database information, GPS data indicating usage of a weigh station, information captured from an on-board diagnostic indicator (OBDI) connector, a vehicle identification number (VIN), tire inflation sensor information, a sound/vibration emitted from the vehicle and captured by a user device, and accelerometer information captured by the vehicle or the user device.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining a type of a vehicle operated by a user;
in response to determining a segment of a navigational route being traversed by the vehicle prohibits the type or is obstructed, presenting a notification to the user of the prohibition or the obstruction through a graphical user interface associated with a device dictating the navigational route;
calculating a reroute that avoids the prohibition and/or the obstruction; and
presenting the reroute to the user.

9. The computer system of claim 8, wherein the calculating comprises calculating a reroute that has a shortest time duration to a destination of two or more possible routes to the destination.

10. The computer system of claim 8, wherein the calculating comprises calculating a reroute that has a shortest distance to a destination of two or more possible routes to the destination.

11. The computer system of claim 8, wherein presenting the notification further comprises:
transmitting a warning notification to one or more emergency service personnel of a possible catastrophic event due to the vehicle traversing the navigational route.

12. The computer system of claim 11, wherein the warning notification comprises characteristic information of the vehicle and a type of emergency services required for the possible catastrophic event.

13. The computer system of claim 8, wherein the notification to the user is presented on a device display screen with information relating to a type of, a distance to, a time duration until the vehicle reaches the prohibition or the obstruction, and one or more alternate routes that avoid the prohibition or the obstruction.

14. The computer system of claim 8, wherein the type is determined through a data selected from a group consisting of a calendar entry showing the vehicle being rented, credit card transaction information, a change in vehicle tongue weight to a positive value when a trailer is on a hitch, a level of the vehicle, a view from a side view or a rear-view window, a view from a back-up camera, a view from a cellphone camera, tolling authority database information, GPS data indicating usage of a weigh station, information captured from an on-board diagnostic indicator (OBDI) connector, a vehicle identification number (VIN), tire inflation sensor information, a sound/vibration emitted from the vehicle and captured by a user device, and accelerometer information captured by the vehicle or the user device.

15. A computer program product, the computer program product comprising:
one or more computer-readable tangible storage medium and program instructions stored on at least one of the one or more tangible storage medium, the program instructions executable by a processor capable of performing a method, the method comprising:
determining a type of a vehicle operated by a user;
in response to determining a segment of a navigational route being traversed by the vehicle prohibits the type or is obstructed, presenting a notification to the user of the prohibition or the obstruction through a graphical user interface associated with a device dictating the navigational route;
calculating a reroute that avoids the prohibition and/or the obstruction; and
presenting the reroute to the user.

16. The computer program product of claim 15, wherein the calculating comprises calculating a reroute that has a shortest time duration to a destination of two or more possible routes to the destination.

17. The computer program product of claim 15, wherein the calculating comprises calculating a reroute that has a shortest distance to a destination of two or more possible routes to the destination.

18. The computer program product of claim 15, wherein presenting the notification further comprises:
transmitting a warning notification to one or more emergency service personnel of a possible catastrophic event due to the vehicle traversing the navigational route.

19. The computer program product of claim 18, wherein the warning notification comprises characteristic information of the vehicle and a type of emergency services required for the possible catastrophic event.

20. The computer program product of claim 15, wherein the notification to the user is presented on a device display screen with information relating to a type of, a distance to, a time duration until the vehicle reaches the prohibition or the obstruction, and one or more alternate routes that avoid the prohibition or the obstruction.
